(19) United States
(12) Patent Application Publication
(10) Pub. No.: US 2020/0141431 A1
(43) Pub. Date: May 7, 2020

(54) Water Flow Accelerator

(71) Applicant: Xiaoying Ning, Beihai, Guangxi (CN)

(72) Inventor: Xiaoying Ning, Beihai, Guangxi (CN)

(21) Appl. No.: 16/304,170

(22) PCT Filed: Mar. 17, 2017
(86) PCT No.: PCT/CN2017/077145

§ 371 Date: Nov. 23, 2018

(30) Foreign Application Priority Data
May 23, 2016 (CN) 201610338049.7

(51) Int. Cl. F15D 1/06; E03F 5/04

(52) U.S. Cl. CPC F15D 1/06; E03F 5/04

(57) ABSTRACT

A water flow accelerator comprises: a water pump; a draining pipe; and an injection annulus having an annular cavity. A water outlet of the water pump is in communication with the annular cavity. The injection annulus has a slot. The slot communicates the annular cavity with an external environment. The draining pipe is connected to a water inlet of the water pump.

The present disclosure claims the priority to the Chinese patent application No. CN201610338049.7, filed with the Chinese Patent Office on May 23, 2016 and entitled “Water Flow Accelerator for Urban Drainage Pipeline”, which is incorporated herein by reference in its entirety.

### TECHNICAL FIELD

The present disclosure belongs to the mechanical technical field, and relates to a water flow accelerator.

### BACKGROUND ART

For historical reasons, some urban planning is not forward-looking, drainage facilities are not scientifically planned, and the drainage pipes are small. After a heavy rain, water flows slowly in the pipes, drainage is not smooth, and standing water on the road becomes ponds. As a result, many places in the cities are flooded and traffic jams occur, which brings great inconvenience to the travel of citizens. Urban drainage pipelines are an important part of urban infrastructure. The urban drainage planning and design play an important role in constructing good urban residential environment and realizing sustainable urban development. Therefore, the designing and optimization of urban drainage pipelines have become an important task of urban construction. In order to solve the problem of urban waterlogging, some cities reconstruct the urban drainage pipelines regardless of financial difficulties, which is so costly as to affect the government's investment on other aspects. Moreover, for the reconstruction, the construction period is long, and the surrounding road surface is destroyed, which also results in bad road traffic.

### SUMMARY

An object of the embodiments of the present disclosure is to provide a water flow accelerator for an urban drainage pipeline, in order to improve the problem that water flows slowly in the urban drainage pipeline.

The other object of the embodiments of the present disclosure is to provide a water flow accelerator, in order to improve the problem that water flows slowly in an urban drainage pipeline.

The embodiments of the present disclosure are implemented by the following technical solutions:

A water flow accelerator for an urban drainage pipeline comprises a water pump, a water pump outlet pipe (i.e. a water outlet pipe of the water pump) with two ends connected to a water outlet of the water pump and an injection/jetting annulus respectively, the injection annulus with two ends connected to the water outlet of the water pump and a shunt draining pipe (shunt water-draining pipe) respectively, and the shunt draining pipe with two ends connected to the injection annulus and the urban drainage pipeline, respectively, wherein the injection annulus is a hollow annulus, the injection annulus is provided at lower end thereof with an opening to communicate with a water pump outlet-connecting pipe, a shell of the annulus is discontinuous and not closed, and the shell of the annulus is provided on inner side thereof with an injection slot-cut.

Further, the water pump outlet pipe is made of metal or plastic.

Further, the shunt draining pipe is made of metal or plastic.

Further, an injection annulus is made of metal or plastic.

A water flow accelerator comprises a water pump, a water draining pipe, and an injection annulus having an annular cavity, wherein a water outlet of the water pump is in communication with the annular cavity, the injection annulus is provided thereon with a slot, the slot communicates the annular cavity with an external environment, and the water draining pipe is connected to a water inlet of the water pump.

Further, an opening direction of the slot is not perpendicular to an axis of the injection annulus.

Further, the slot has a shape of a ring extending along the injection annulus.

Further, the slot is located on an inner circumferential surface of the injection annulus.

Further, on an axial section of the injection annulus, the annular cavity comprises a first chamber and a second chamber communicating with each other, the width of the second chamber gradually decreases in a direction away from the first chamber, and the slot is in direct communication with the first chamber.

Further, an axial sectional profile of the injection annulus comprises a first profile edge, a second profile edge, a third profile edge and a fourth profile edge; the second profile edge and the third profile edge extend downwardly from two ends of the first profile edge, respectively, and on the same side of the first profile edge; in an extending direction of the third profile edge, the distance between the third profile edge and the first profile edge is gradually increased; the fourth profile edge extends from an end of the third profile edge away from the first profile edge towards the first profile edge; and the fourth profile edge is staggered with and spaced apart from one end of the second profile edge away from the first profile edge, so as to form a slot.

Further, the third profile edge comprises a first sub-profile edge and a second sub-profile edge; the first profile edge, the first sub-profile edge, the second sub-profile edge and the fourth profile edge are sequentially connected; and the angle between the first sub-profile edge and the first profile edge is greater than the angle between an extension line of the second sub-profile edge and an extension line of the first profile edge.

Further, the second profile edge and the fourth profile edge are both an arc protruding in a direction away from the first profile edge.

Further, the water outlet of the water pump communicates with the annular cavity through a water outlet pipe.

Further, the water outlet pipe comprises a first water outlet pipe and a second water outlet pipe; the first water outlet pipe and the second water outlet pipe are connected to each other; the first water outlet pipe is connected to the water outlet of the water pump; and the second water outlet pipe is connected to the injection annulus.

Further, an end of the water draining pipe is connected to the injection annulus.

Further, an end of the water draining pipe is connected to the injection annulus through an annular pipe.

Further, the water draining pipe is connected to the water inlet of the water pump through a water inlet pipe.

Further, the water inlet pipe comprises a first water inlet pipe and a second water inlet pipe; the first water inlet pipe and the second water inlet pipe are connected to each other; the first water inlet pipe is connected to the water draining pipe; and the second water inlet pipe is connected to the water inlet of the water pump.

Further, the water pump is fixedly connected to a fixing base.

The water flow accelerator for an urban drainage pipeline provided in the embodiments of the present disclosure can be used in an urban drainage pipeline. Water in an urban drainage pipeline is delivered into an injection annulus by a water pump, and is then ejected out through an injection slot-cut on the injection annulus. In this way, the flow velocity of the water in the urban drainage pipeline is increased, and therefore the problem that water flows slowly in the urban drainage pipeline is improved.

The water flow accelerator provided in the embodiments of the present disclosure can be used in an urban drainage pipeline. Water in an urban drainage pipeline is delivered into an injection annulus by a water pump, and is then ejected out through a slot on the injection annulus. In this way, the flow velocity of the water in the urban drainage pipeline is increased, and therefore the problem that water flows slowly in the urban drainage pipeline is improved.

### BRIEF DESCRIPTION OF DRAWINGS

In order to more clearly illustrate the technical solutions of the embodiments of the present disclosure, brief description is made below on the drawings required to be used in the embodiments. It should be understood that the following drawings only illustrate some of the embodiments of the present disclosure and shall not be regarded as a limitation to the scope of the present disclosure. For a person skilled in the art, other drawings may be obtained according to these drawings without inventive effort.

FIG. 1 is a schematic structural diagram of a water flow accelerator provided in some embodiments of the present disclosure;

FIG. 2 is an axial sectional view of an injection annulus of a water flow accelerator provided in some embodiments of the present disclosure; and

FIG. 3 is a schematic structural diagram of a water flow accelerator provided in some embodiments of the present disclosure.

In the drawings: 1—water pump; 2—first water outlet pipe; 3—second water outlet pipe; 4—injection annulus; 5—slot; 6—annular pipe; 7—draining pipe; 8—first water inlet pipe; 9—second water inlet pipe; 10—fixing base; 11—hanger; 30—water outlet pipe; 51—first flange; 52—second flange; 70—water inlet pipe; 410—annular cavity; 411—first chamber; 412—second chamber; 421—first profile edge; 422—second profile edge; 423—third profile edge; 424—fourth profile edge; 4231—first sub-profile edge; and 4232—second sub-profile edge.

### DETAILED DESCRIPTION OF EMBODIMENTS

In order to make the objects, technical solutions and advantages of the embodiments of the present disclosure clearer, the technical solutions of the embodiments of the present disclosure will be described clearly and completely below with reference to the drawings. Apparently, the embodiments described are some of the embodiments of the present disclosure, rather than all of the embodiments.

Thus, the following detailed description of the embodiments of the present disclosure is not intended to limit the scope of the present disclosure claimed, but only represents some of the embodiments of the present disclosure. All the other embodiments that are obtained by a person of ordinary skills in the art on the basis of the embodiments of the present disclosure without inventive effort shall be covered by the protection scope of the present disclosure.

It should be noted that the embodiments of the present disclosure and the features and technical solutions of the embodiments can be combined with each other if there is no conflict.

It should be noted that like reference signs and letters denote like items in the drawings below, and therefore, once a certain item is defined in one drawing, it does not need to be further defined or explained in the following figures.

In the description of the present disclosure, it should be noted that the terms such as “first” and “second” are only used for differentiated description and cannot be understood as indication or implication of relative importance.

It should be further noted that the first water outlet pipe is also referred to as a water pump outlet pipe; the second water outlet pipe is also referred to as a water pump outlet-connecting pipe; the shunt draining pipe is also referred to as a water draining pipe; the first water inlet pipe is also referred to as a water pump inlet-connecting pipe; the second water inlet pipe is also referred to as a water pump inlet pipe; the injection annulus-connecting pipe is also referred to as an annular pipe; the injection slot-cut is also referred to as a slot; and the water pump fixing base is also referred to as a fixing base.

### Embodiment 1

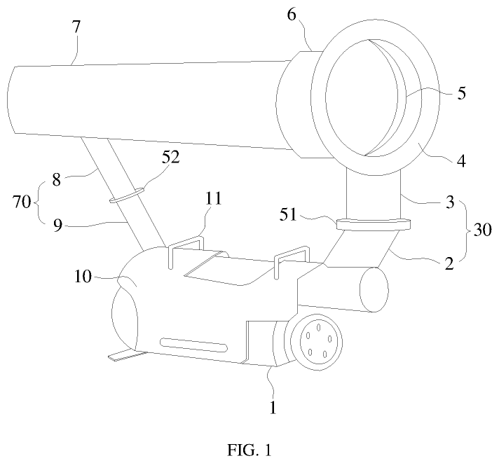

Referring to FIG. 1, the present embodiment provides a water flow accelerator for urban drainage, comprising a water pump 1, a water pump outlet pipe 2 with two ends connected to a water outlet of the water pump 1 and an injection annulus 4, respectively, the injection annulus 4 with two ends connected to the water outlet of the water pump 1 and a shunt draining pipe 7, respectively, and the shunt draining pipe 7 with two ends connected to the injection annulus 4 and an urban drainage pipeline, respectively. The injection annulus 4 is a hollow annulus, its shell is discontinuous and not closed, and the shell of the annulus is provided on inner side thereof with an injection slot-cut 5.

In this embodiment, the water pump outlet pipe 2 is made of metal. It will be appreciated that in other embodiments, the water pump outlet pipe 2 may also be made of plastic.

In this embodiment, the shunt draining pipe 7 is made of metal. It will be appreciated that in other embodiments, the shunt draining pipe 7 may also be made of plastic.

In this embodiment, the injection annulus 4 is made of metal. It will be appreciated that in other embodiments, the injection annulus 4 may also be made of plastic.

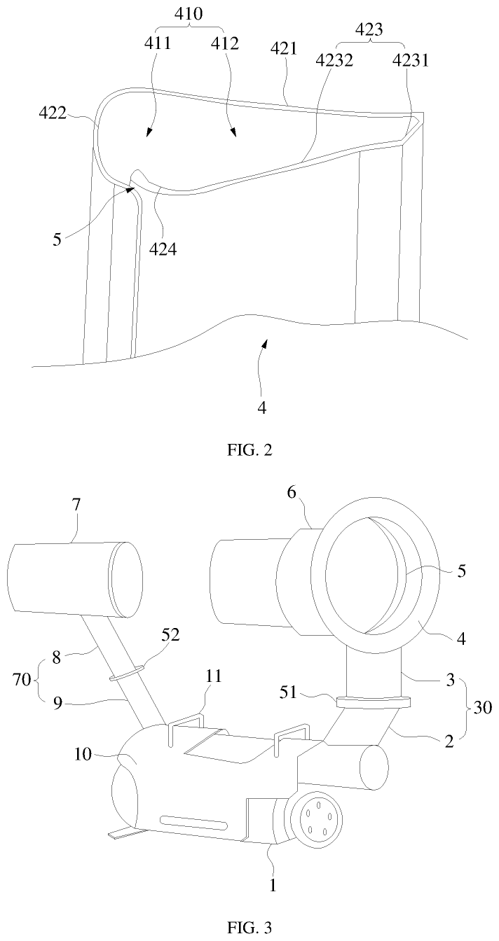

Referring to FIG. 1 again, the water flow accelerator for urban drainage provided in this embodiment comprises a water pump 1, a water pump outlet pipe 2, a water pump outlet-connecting pipe 3, an injection annulus 4, a shunt draining pipe 7, a water pump inlet-connecting pipe 8, a water pump inlet pipe 9 and a water pump fixing base 10. Referring to FIG. 2, the injection annulus 4 is a hollow annulus, and the shell of the injection annulus 4 is discontinuous and not closed, so that an injection slot channel 5 is formed on the inner side of the injection annulus 4. The injection annulus 4 is provided with on outer circumferential surface thereof an opening connected to one end of the water pump outlet-connecting pipe 3 (not shown in the Figure). One end of the water pump outlet pipe 2 is connected to the water outlet of the water pump 1, and the other end of the water pump outlet pipe 2 is connected to the other end of the water pump outlet-connecting pipe 3. In this embodiment, the water pump outlet pipe 2 is connected to the water pump outlet-connecting pipe 3 through a first flange 51. One end of the water pump inlet-connecting pipe 8 is connected to the shunt draining pipe 7. The water pump inlet pipe 9 is connected to the water inlet of the water pump 1. The other end of the water pump inlet-connecting pipe 8 is connected to the other end of the water pump inlet pipe 9. In this embodiment, the water pump inlet-connecting pipe 8 is connected to the water pump inlet pipe 9 through a second flange 52. One side surface of the injection annulus 4 is connected to the end surface of one end of the shunt draining pipe 7, so that the space defined by the inner surface of the injection annulus 4 communicates with the shunt draining pipe 7. In this embodiment, in order to solve the problem that the diameter of the shunt draining pipe 7 and the diameter of the injection annulus 4 differ greatly, an injection annulus-connecting pipe 6 is provided for connection of the injection annulus 4 to the shunt draining pipe 7. It will be understood that the shunt draining pipe 7 may also be directly connected to the injection annulus 4, if the diameter of the shunt draining pipe 7 and the diameter of the injection annulus 4 do not differ greatly. For example, one end of the shunt draining pipe 7 connected to the injection annulus 4 is made into a port having a slightly smaller diameter than the injection annulus 4 and then welding is performed. The water pump fixing base 10 is formed by bending an iron plate, and two hangers 11 are provided on the outer surface of the water pump fixing base 10. The water pump fixing base 10 is sleeved on the water pump 1, and the water pump 1 is fixed by means of the hangers 11. The water pump outlet pipe 2 is made of metal. The shunt draining pipe 7 is made of metal. The injection annulus 4 is made of metal.

When the water flow accelerator for urban drainage provided in this embodiment is put into use, one end of the shunt draining pipe 7 away from the injection annulus 4 is connected to an urban drainage pipeline. The injection annulus 4 may or may not be connected to the urban drainage pipeline. When the injection annulus 4 is connected to the urban drainage pipeline, the injection annulus 4 is connected to the urban drainage pipeline through a flange or directly connected to the urban drainage pipeline via welding.

When the injection annulus 4 is not connected to the urban drainage pipeline, the injection annulus 4 may be placed at a low-lying place. When the water flows slowly in the urban drainage pipeline and cannot be drained in time, the water flow accelerator for urban drainage provided in this embodiment is started. The water pump 1 pumps the water out from the urban drainage pipeline through shunt draining pipe 7 and delivers the water to the injection annulus 4. Under the effect of the pressure generated by the water pump 1, the water in the injection annulus 4 is ejected out through the injection slot-cut 5. When the water is ejected out through the injection slot-cut 5, the flow velocity is relatively high, which increases the flow velocity of the water in the low-lying place. As can be known according to Bernoulli's law, when the flow velocity of the water in the low-lying place increases, the water pressure of the water in the low-lying place becomes lower, which thereby speeds up the water flow in the urban drainage pipeline, so that the water in the urban drainage pipeline is quickly drained to the low-lying place through the shunt draining pipe 7. In this way, the drainage speed of water in the urban drainage pipeline is increased, and therefore the problem of standing water on the urban roads is alleviated.

When the injection annulus 4 is connected to the urban drainage pipeline, if water flows slowly in the urban drainage pipeline, the water flow accelerator for urban drainage provided in this embodiment is started. The water pump 1 pumps water out from the urban drainage pipeline through the shunt draining pipe 7 and delivers the water to the injection annulus 4. Under the effect of the pressure generated by the water pump 1, the water in the injection annulus 4 is ejected out through the injection slot-cut 5. At the same time, the water in the urban drainage pipeline connected to the shunt draining pipe 7 enters, through the shunt draining pipe 7 and the injection annulus 4, the urban drainage pipeline connected to the injection annulus 4. When the water is ejected out through the injection slot-cut 5, the velocity is relatively high, which increases the flow velocity of the water in the urban drainage pipeline connected to the injection annulus 4. As can be known according to Bernoulli's law, when the flow velocity of the water in the urban drainage pipeline connected to the injection annulus 4 increases, the water pressure of the water therein becomes lower, so that the water in the urban drainage pipeline connected to the shunt draining pipe 7 can quickly enter, through the shunt draining pipe 7, the urban drainage pipeline connected to the injection annulus 4, and therefore the flow velocity of the water in the urban drainage pipeline is sped up, which improves the drainage capacity of the urban drainage pipeline, and further alleviates the problem of standing water on the urban roads.

When the water flow accelerator for urban drainage provided in this embodiment is put into use, it is only necessary to install the same in the existing urban drainage pipeline in order to alleviate the problem of standing water on the urban roads, and there is no need to carry out large-scale reconstruction on the urban drainage pipelines, thereby saving costs.

### Embodiment 2

Referring to FIG. 3, the present embodiment also provides a water flow accelerator for urban drainage. The water flow accelerator for urban drainage provided in this embodiment is substantially the same as that provided in embodiment 1, except that the shunt draining pipe 7 in this embodiment is not connected to the injection annulus 4. This difference enables the water pump 1 to pump, through the water pump inlet-connecting pipe 8, the water pump inlet pipe 9 and the shunt draining pipe 7, water at a position away from the injection annulus 4, which imparts greater flexibility to the installation and arrangement of the water flow accelerator for urban drainage provided in this embodiment.

### Embodiment 3

Referring to FIG. 1, the present embodiment provides a water flow accelerator, comprising a water pump 1, an injection annulus 4 and a water draining pipe 7.

Referring also to FIG. 2, FIG. 2 is an axial sectional view of the injection annulus 4 of the water flow accelerator provided in this embodiment, wherein the axial section refers to a section taken by cutting the injection annulus 4 along the plane in which the axis of the injection annulus 4 is located. As can be seen from FIG. 2, the injection annulus 4 has an annular cavity 410. The injection annulus 4 is provided with a slot 5 which communicates the annular cavity 410 with an external environment. The water outlet of the water pump 1 is connected to the injection annulus 4, and the water outlet of the water pump 1 is in communication with the annular cavity 410. The water draining pipe 7 is connected to the water inlet of the water pump 1. One end of the water draining pipe 7 is connected to the injection annulus 4. Further, one side surface of the injection annulus 4 is connected to the end surface of one end of the water draining pipe 7, so that the space defined by the inner surface of the injection annulus 4 communicates with the water draining pipe 7.

When the water flow accelerator provided in this embodiment is put into use, one end of the water draining pipe 7 away from the injection annulus 4 is connected to an urban drainage pipeline. The injection annulus 4 may or may not be connected to the urban drainage pipeline. When the injection annulus 4 is connected to the urban drainage pipeline, the injection annulus 4 is connected to the urban drainage pipeline through a flange or directly connected to the urban drainage pipeline via welding.

When the injection annulus 4 is not connected to the urban drainage pipeline, the injection annulus 4 may be placed at a low-lying place. When the water flows slowly in the urban drainage pipeline and cannot be drained in time, the water flow accelerator provided in this embodiment is started. The water pump 1 pumps the water out from the urban drainage pipeline through the water draining pipe 7 and delivers the water to the injection annulus 4. Under the effect of the pressure generated by the water pump 1, the water in the injection annulus 4 is ejected out through the slot 5. When the water is ejected out through the slot 5, the velocity is relatively high, which increases the flow velocity of the water in the low-lying place. As can be known according to Bernoulli's law, when the flow velocity of the water in the low-lying place increases, the water pressure of the water in the low-lying place becomes lower, which thereby speeds up the water flow in the urban drainage pipeline, so that the water in the urban drainage pipeline is quickly drained to the low-lying place through the water draining pipe 7. In this way, the drainage speed of water in the urban drainage pipeline is increased, and therefore the problem of standing water on the urban roads is alleviated.

When the injection annulus 4 is connected to the urban drainage pipeline, if water flows slowly in the urban drainage pipeline, the water flow accelerator provided in this embodiment is started. The water pump 1 pumps water out from the urban drainage pipeline through the water draining pipe 7 and delivers the water to the injection annulus 4. Under the effect of the pressure generated by the water pump 1, the water in the injection annulus 4 is ejected out through the slot 5. At the same time, the water in the urban drainage pipeline connected to the water draining pipe 7 enters, through the water draining pipe 7 and the injection annulus 4, the urban drainage pipeline connected to the injection annulus 4. When the water is ejected out through the slot 5, the velocity is relatively high, which increases the flow velocity of the water in the urban drainage pipeline connected to the injection annulus 4. As can be known according to Bernoulli's law, when the flow velocity of the water in the urban drainage pipeline connected to the injection annulus 4 increases, the water pressure of the water therein becomes lower, so that the water in the urban drainage pipeline connected to the water draining pipe 7 can quickly enter, through the water draining pipe 7, the urban drainage pipeline connected to the injection annulus 4, and therefore the flow velocity of the water in the urban drainage pipeline is sped up, which improves the drainage capacity of the urban drainage pipeline, and further alleviates the problem of standing water on the urban roads.

When the water flow accelerator for urban drainage provided in this embodiment is put into use, it is only necessary to install the same in the existing urban drainage pipeline in order to alleviate the problem of standing water on the urban roads, and there is no need to carry out large-scale reconstruction on the urban drainage pipelines, thereby saving costs.

The water flow accelerator provided in this embodiment will be further described as followings.

In this embodiment, the opening direction of the slot 5 is not perpendicular to the axis of the injection annulus 4. In this way, the water ejected from the slot 5 can more fully speed up the water in the low-lying place or the water in the urban drainage pipeline in the drainage direction, thereby further improving the drainage capacity of the urban drainage pipeline. It is to be understood that the opening direction of the slot 5 may be perpendicular to the axis of the injection annulus 4 in other embodiments.

In this embodiment, the slot 5 has a shape of a ring extending along the injection annulus 4, so that the water that can be ejected through the slot 5 can be ejected annularly, so as to more efficiently speed up the water in the low-lying place or the water in the urban drainage pipeline in the drainage direction. It is to be understood that the slot 5 may not be ring-shaped in other embodiments.

In this embodiment, the slot 5 is located on an inner circumferential surface of the injection annulus 4. In this way, when the injection annulus 4 is connected to the urban drainage pipeline, the water ejected from the slot 5 can directly enter the urban drainage pipeline. It is to be understood that in other embodiments, the slot 5 may also be provided on a side surface or the outer circumferential surface of the injection annulus 4.

In this embodiment, referring to FIG. 2, on an axial section of the injection annulus 4, the annular cavity 410 comprises a first chamber 411 and a second chamber 412 communicating with each other, the width of the second chamber 412 gradually decreases in a direction away from the first chamber 411, and the slot 5 is in direct communication with the first chamber 411. The slot 5, the first chamber 411 and the second chamber 412 are formed in a manner as follows. The axial sectional profile of the injection annulus 4 comprises a first profile edge 421, a second profile edge 422, a third profile edge 423 and a fourth profile edge 424; the second profile edge 422 and the third profile edge 423 extend downwardly from two ends of the first profile edge 421, respectively, and on the same side of the first profile edge 421; in an extending direction of the third profile edge 423, the distance between the third profile edge 423 and the first profile edge 421 is gradually increased; the fourth profile edge 424 extends from an end of the third profile edge 423 away from the first profile edge 421 towards the first profile edge 421; and the fourth profile edge 424 is staggered with and spaced apart from one end of the second profile edge 422 away from the first profile edge 421 to form slot 5. The space between the first profile edge 421 and the third profile edge 423 constitutes the second chamber 412. The space between the first profile edge 421, the second profile edge 422 and the fourth profile edge 424 constitutes the first chamber 411. Optionally, the second profile edge 422 and the fourth profile edge 424 are both an arc protruding in a direction away from the first profile edge 421. Optionally, the third profile edge 423 may further comprise a first sub-profile edge 4231 and a second sub-profile edge 4232; the first profile edge 421, the first sub-profile edge 4231, the second sub-profile edge 4232 and the fourth profile edge 424 are connected together sequentially; and the angle between the first sub-profile edge 4231 and the first profile edge 421 is greater than the angle between an extension line of the second sub-profile edge 4232 and an extension line of the first profile edge 421.

In this embodiment, referring to FIG. 1, the water outlet of the water pump 1 communicates with the annular cavity 410 through a water outlet pipe 30. The water outlet pipe 30 comprises a first water outlet pipe 2 and a second water outlet pipe 3; the first water outlet pipe 2 and the second water outlet pipe 3 are connected to each other through a first flange 51; the first water outlet pipe 2 is connected to the water outlet of the water pump 1; and the second water outlet pipe 3 is connected to the injection annulus 4. It is to be understood that in other embodiments, the water outlet of the water pump 1 may communicate with the annular cavity 410 in other ways, for example, the injection annulus 4 is disposed directly at the water outlet of the water pump 1, so that the water outlet of the water pump 1 communicates with the annular cavity 410.

In this embodiment, referring to FIG. 1, the water draining pipe 7 is connected to the water inlet of the water pump 1 through a water inlet pipe 70. The water inlet pipe 70 comprises a first water inlet pipe 8 and a second water inlet pipe 9; the first water inlet pipe 8 and the second water inlet pipe 9 are connected to each other through a second flange 52; the first water inlet pipe 8 is connected to the water draining pipe 7; and the second water inlet pipe 9 is connected to the water inlet of the water pump 1. It is to be understood that in other embodiments, the water inlet of the water pump 1 may also be connected to the water draining pipe 7 in other ways, for example, the water inlet of the water pump 1 is directly connected to the water draining pipe 7.

In this embodiment, in order to solve the problem that the diameter of the water draining pipe 7 and the diameter of the injection annulus 4 differ greatly, an annular pipe 6 is provided for connection of the injection annulus 4 and the water draining pipe 7. It will be understood that the water draining pipe 7 may also be directly connected to the injection annulus 4, if the diameter of the water draining pipe 7 and the diameter of the injection annulus 4 do not differ greatly. For example, one end of the water draining pipe 7 connected to the injection annulus 4 is made into a port having a slightly smaller diameter than the injection annulus 4 and then welding is performed.

In this embodiment, referring to FIG. 1, for better fixing of the water pump 1, a fixing base 10 is further provided. The fixing base 10 is formed by bending an iron plate, and two hangers 11 are provided on the outer surface of the fixing base 10. The fixing base 10 is sleeved on the water pump 1, and fixes the water pump 1 by means of the hangers 11.

### Embodiment 4

Referring to FIG. 3, the present embodiment also provides a water flow accelerator. The water flow accelerator provided in this embodiment is substantially the same as that provided in embodiment 3, except that the water draining pipe 7 in this embodiment is not connected to the injection annulus 4. This difference enables the water pump 1 to pump, through the water inlet pipe 70 and the water draining pipe 7, water at a position away from the injection annulus 4, which imparts greater flexibility to the installation and arrangement of the water flow accelerator provided in this embodiment.

Obviously, the above-described embodiments of the present disclosure are merely examples listed for clear illustration of the present disclosure, rather than limiting the implementation modes of the present disclosure. For a person of ordinary skills in the art, other different forms of variations or changes can be made on the basis of the above description. There is no need to list all the implementation modes here, which is also impossible. Any modifications, equivalent substitutions, improvements, etc. within the spirit and principle of the present disclosure shall all be included in the scope of protection of the claims of the present disclosure.

1. A water flow accelerator for an urban drainage pipeline, comprising:
a water pump,
a water pump outlet pipe with two ends connected to a water outlet of the water pump and an injection annulus, respectively,
the injection annulus with two ends connected to the water outlet of the water pump and a shunt draining pipe, respectively, and
the shunt draining pipe with two ends connected to the injection annulus and the urban drainage pipeline, respectively,
wherein the injection annulus is a hollow annulus, a lower end of the injection annulus is provided with an opening to communicate with a water pump outlet-connecting pipe, a shell of the injection annulus is discontinuous and not closed, and an inner side of the shell is provided with an injection slot-cut.

2. The water flow accelerator for an urban drainage pipeline according to claim 1, wherein the water pump outlet pipe is made of a metal or a plastic.

3. The water flow accelerator for an urban drainage pipeline according to claim 1, wherein the shunt draining pipe is made of a metal or a plastic.

4. The water flow accelerator for an urban drainage pipeline according to claim 1, wherein the injection annulus is made of a metal or a plastic.

5. A water flow accelerator,
comprising a water pump, a water draining pipe, and an injection annulus having an annular cavity, wherein a water outlet of the water pump is in communication with the annular cavity, the injection annulus is provided thereon with a slot, the slot enables the annular cavity to communicate with an external environment, and the water draining pipe is connected to a water inlet of the water pump.

6. The water flow accelerator according to claim 5, wherein
an opening direction of the slot is not perpendicular to an axis of the injection annulus.

7. The water flow accelerator according to claim 5, wherein
the slot is in a shape of a ring extending along the injection annulus.

8. The water flow accelerator according to claim 7, wherein
the slot is located at an inner circumferential surface of the injection annulus.

9. The water flow accelerator according to claim 5, wherein
on an axial section of the injection annulus, the annular cavity comprises a first chamber and a second chamber communicating with each other; a width of the second chamber gradually decreases in a direction away from the first chamber; and
the slot is in direct communication with the first chamber.

10. The water flow accelerator according to claim 9, wherein
an axial sectional profile of the injection annulus comprises a first profile edge, a second profile edge, a third profile edge and a fourth profile edge; the second profile edge and the third profile edge extend downwardly from two ends of the first profile edge respectively, and is located at a same side of the first profile edge; in an extending direction of the third profile edge, a distance between the third profile edge and the first profile edge is gradually increased; the fourth profile edge extends towards the first profile edge from an end of the third profile edge away from the first profile edge; and the fourth profile edge is staggered with and spaced apart from one end of the second profile edge away from the first profile edge, so as to form the slot.

11. The water flow accelerator according to claim 10, wherein
the third profile edge comprises a first sub-profile edge and a second sub-profile edge; the first profile edge, the first sub-profile edge, the second sub-profile edge and the fourth profile edge are connected together sequentially; and an angle between the first sub-profile edge and the first profile edge is greater than an angle between an extension line of the second sub-profile edge and an extension line of the first profile edge.

12. The water flow accelerator according to claim 10, wherein
the second profile edge and the fourth profile edge are each in an arc shape protruding in a direction away from the first profile edge.

13. The water flow accelerator according to claim 5, wherein
the water outlet of the water pump communicates with the annular cavity through a water outlet pipe.

14. The water flow accelerator according to claim 13, wherein
the water outlet pipe comprises a first water outlet pipe and a second water outlet pipe; the first water outlet pipe and the second water outlet pipe are connected to each other; the first water outlet pipe is connected to the water outlet of the water pump; and the second water outlet pipe is connected to the injection annulus.

15. The water flow accelerator according to claim 5, wherein
an end of the water draining pipe is connected to the injection annulus.

16. The water flow accelerator according to claim 15, wherein
the end of the water draining pipe is connected to the injection annulus through an annular pipe.

17. The water flow accelerator according to claim 5, wherein
the water draining pipe is connected to the water inlet of the water pump through a water inlet pipe.

18. The water flow accelerator according to claim 17, wherein
the water inlet pipe comprises a first water inlet pipe and a second water inlet pipe; the first water inlet pipe and the second water inlet pipe are connected to each other; the first water inlet pipe is connected to the water draining pipe; and the second water inlet pipe is connected to the water inlet of the water pump.

19. The water flow accelerator according to claim 5, wherein
the water pump is fixedly connected to a fixing base.

20. The water flow accelerator according to claim 6, wherein
on an axial section of the injection annulus, the annular cavity comprises a first chamber and a second chamber communicating with each other; a width of the second chamber gradually decreases in a direction away from the first chamber; and
the slot is in direct communication with the first chamber.
